(19) United States
(12) Patent Application Publication
(10) Pub. No.: US 2015/0135120 A1
(43) Pub. Date: May 14, 2015

(54) TOUCH PANEL INPUT DEVICE, AND IMAGE FORMATION DEVICE

(71) Applicant: Sharp Kabushiki Kaisha, Osaka (JP)

(72) Inventor: Hiroshi TANAKA, Osaka (JP)

(21) Appl. No.: 14/382,418

(22) PCT Filed: Apr. 11, 2013
(86) PCT No.: PCT/JP2013/060929

§ 371 Date: Sep. 2, 2014

(30) Foreign Application Priority Data
Apr. 23, 2012 (JP) 2012-097480
Apr. 27, 2012 (JP) 2012-102044

(51) Int. Cl. G06F 3/0488; G06F 3/0485; G06F 3/0484

(52) U.S. Cl. CPC G06F 3/04886; G06F 3/04842; G06F 3/04855
USPC 715/773

(57) ABSTRACT

In a touch panel input device, in cases when display and input functions fail in one area, touch keys can be displayed without modifying the normal touch-key-image layout, while retaining the normal touch-key-image layout relationship. When a touch panel input device fails, a designation for an alternative display area (51) for displaying a touch-key image while avoiding a failure area (41) is received from a user. The touch-key image normally displayed is reduced and displayed in the alternative display area (51). The alternative display area may also be in a plurality of places. In such a case, the touch-key image normally displayed is divided, respectively reduced and displayed. Furthermore, the touch-key image maybe displayed in the alternative display area (51) in a scrollable manner.

### TECHNICAL FIELD

The present invention relates to a touch panel input device and an image formation device, and more specifically relates to a touch panel input device provided with a display function at a time of failure, and an image formation device.

### BACKGROUND OF THE INVENTION

For an operation panel of various equipment to be operated including an image formation device such as a copier and a household electrical appliance, a display device having a touch panel embedded is used. Then, a predetermined operation is able to be performed by touching a touch key displayed on the touch panel, so that operability is good, while there is a problem that a part of the touch key whose frequency of use is high is easy to break.

Therefore, for example, Patent Document 1 discloses that, in a case where a faulty area overlaps a key input valid area when a fault of a touch screen occurs, screen display is modified so that the key input valid area is moved to a non-faulty part. Further, Patent Document 2 discloses a touch panel device in which a button desired to function is able to be set in a non-failure area of a touch panel by deviating connection between physical positions of a layout of the button and the touch panel in a case where the touch panel button fails. In addition, Patent Literature 3 discloses that it is detected that a touch panel is in a failure state so that a selection button is not displayed in a position which is judged to be a failure part.

### PRIOR ART DOCUMENT

### Patent Documents

Patent Document 1: Japanese Laid-Open Patent Publication No. H6-95802
Patent Document 2: Japanese Laid-Open Patent Publication No. H7-271495
Patent Document 3: Japanese Laid-Open Patent Publication No. 2008-70963

### SUMMARY OF THE INVENTION

### Problem to be Solved by the Invention

Normally, a touch panel device causes a display device such as a liquid crystal display device to display a button image or a key image (hereinafter, referred to as “touch key”) and detects that a user presses a position on the touch panel corresponding to a display position of the touch key. Then, a display layout of a touch key is devised variously depending on equipment to be operated and designed so as to become a layout which is easy to use for the user. Moreover, the user also has an advantage that occurrence of a mistake of a touch operation is reduced by performing an operation based on a layout of a touch key being accustomed to use.

In technologies disclosed in Patent Literatures 1 to 3, however, by modifying a layout of a touch key in a normal display screen at a time of failure of the touch panel, the touch key is not to be displayed in a failure part. Accordingly, the user needs to perform an operation in accordance with a layout of a touch key which is completely different from a normal one at the time of failure, so that there has been a problem that operability is bad due to unfamiliarity and an erroneous operation is caused.

The present invention has been made in view of these circumstances, and an object thereof is to provide a touch panel input device that, even in a case where display and input functions fail in a partial area in the touch panel input device, is able to display a touch key without modifying a normal touch-key-image layout (arrangement), while retaining the touch-key-image layout relationship (arrangement relationship) which is the same as a normal one, and an image formation device.

### Means for Solving the Problem

To solve the above problems, a first technical means of the present invention is a touch panel input device which displays a touch-key image including at least one or more touch keys on a display screen, detects a fact that the touch key is contacted, and receives input according to the touch key displayed in a contacted area, wherein the touch panel input device includes an alternative display area setting portion for receiving designation of an alternative display area which is usable at a time of failure as well as a display control portion for performing display in a state of retaining an arrangement relationship of the one or more touch keys in the alternative display area.

A second technical means is the touch panel input device of the first technical means, wherein the display control portion includes a reduction rate calculating portion for calculating a reduction rate when the touch-key image is displayed in the alternative display area and an image data reducing portion for reducing the touch-key image based on the reduction rate calculated by the reduction rate calculating portion, and displays the touch-key image reduced by the image data reducing portion in the alternative display area.

A third technical means is the touch panel input device of the first technical means, wherein the alternative display area setting portion receives designation of a plurality of the alternative display areas.

A fourth technical means is the touch panel input device of the first technical means, wherein the display control portion has an image data scroll display portion for displaying the touch-key image to be scrollable in the alternative display area.

A fifth technical means is the touch panel input device of the fourth technical means, wherein a scroll bar is displayed along with the touch-key image in the alternative display area.

A sixth technical means is the touch panel input device of the fourth technical means, wherein a touch-key image which is initially displayed in the alternative display area is apart of a touch-key image normally displayed on the display screen.

A seventh technical means is the touch panel input device of any one of the first technical means, wherein the alternative display area setting portion specifies a coordinate position of a start point and a coordinate position of an endpoint which are designated on the display screen and sets a rectangular area, as the alternative display area, which has a line connecting the coordinate position of the start point and the coordinate position of the end point as a diagonal line.

An eighth technical means is the touch panel input device of the seventh technical means, wherein the alternative display area setting portion specifies a position at which a user has a contact on the display screen as the coordinate position of the start point and specifies a position at which, after the user slides the contact position on the display screen, no contact is made by the user on the display screen as the coordinate position of the end point.

A ninth technical means is the touch panel input device of the eighth technical means, wherein when the user is sliding the contact position on the display screen, the alternative display area setting portion highlights a rectangular area having a line connecting the coordinate position of the start point and the contact position when sliding as a diagonal line.

A tenth technical means is the touch panel input device of the fourth technical means, wherein the alternative display area setting portion specifies a position of an apex designated by a drag operation from a peripheral part of the touch-key image normally displayed and sets, as the alternative display area, a rectangular area having a line connecting the specified apex and an apex of the touch-key image normally displayed, which is at a position opposed to the specified apex, as a diagonal line.

An eleventh technical means is the touch panel input device of the tenth technical means, wherein the touch-key image is moved and displayed according to a drag operation from a peripheral part of the display screen.

A twelfth technical means is the touch panel input device of the first technical means, wherein a predetermined image different from that of the alternative display area is displayed on a display screen outside the alternative display area.

A thirteenth technical means is the touch panel input device of the first technical means, wherein a caution image to the effect that the touch panel input device does not work is displayed on the alternative display.

A fourteenth technical means is an image formation device provided with the touch panel input device of the first technical means.

### Effect of the Invention

According to the present invention, when there is a failure area in a part of the touch panel input device, by reducing and displaying a touch-key image in an alternative display area which is a non-failure area, a touch-key image which has an arrangement same as a normal one is able to be displayed without a defect. Therefore, even at a time of failure, an operation is able to be performed in accordance with a layout of the touch key completely same as a normal one, so that usability is not degraded and an operation mistake due to unfamiliarity is able to be prevented.

### BRIEF DESCRIPTION OF DRAWINGS

FIG. 1 is a structural diagram of an image formation device provided with a touch panel input device according to one embodiment of the present invention.

FIG. 2 is a diagram showing an example of a touch-key image displayed on a display screen in the touch panel input device according to one embodiment of the present invention.

FIG. 3 is a diagram showing a failure part in the touch panel input device in which the touch-key image of FIG. 2 is displayed.

FIG. 4 is diagram explaining a method for setting an alternative display area.

FIG. 5 is a diagram explaining a touch-key image displayed in the alternative display area in the touch panel input device according to one embodiment of the present invention.

FIG. 6 is a diagram when a reduced touch-key image is displayed in the alternative display area in the touch panel input device according to one embodiment of the present invention.

FIG. 7 is a diagram when an image different from that of the alternative display area is displayed on a display screen other than the alternative display area in the touch panel input device according to one embodiment of the present invention.

FIG. 8 is a diagram when a caution image is displayed together in the alternative display area in the touch panel input device according to one embodiment of the present invention.

FIG. 9 is a flowchart showing processing procedure of the touch panel input device according to one embodiment of the present invention.

FIG. 10 is a diagram showing a failure part in the touch panel input device in which the touch-key image of FIG. 2 is displayed.

FIG. 11 is a diagram explaining a method at a time of setting two alternative display areas.

FIG. 12 is a diagram explaining touch-key images displayed in alternative display areas in a touch panel input device according to another embodiment of the present invention.

FIG. 13 is a diagram when a reduced touch-key image is displayed in the alternative display areas in the touch panel input device according to another embodiment of the present invention.

FIG. 14 is a structural diagram of an image formation device provided with the touch panel input device according to another embodiment of the present invention.

FIG. 15A is a flowchart showing processing procedure of the touch panel input device according to another embodiment of the present invention.

FIG. 15B is a flowchart showing continuation of FIG. 15A.

FIG. 16 is a structural diagram of an image formation device provided with a touch panel input device according to still another embodiment of the present invention.

FIG. 17 is a diagram when a touch-key image is displayed in the alternative display area in the touch panel input device according to still another embodiment of the present invention.

FIG. 18 is a diagram when the touch-key image of FIG. 17 is subjected to scroll display.

FIG. 19 is a flowchart showing processing procedure of the touch panel input device according to still other embodiments of the present invention.

FIG. 20 is a diagram explaining another example of a method for setting an alternative display area in the touch panel input device according to still another embodiment of the present invention.

FIG. 21 is a diagram explaining still another example of a method for setting an alternative display area in the touch panel input device according to still another embodiment of the present invention.

FIG. 22 is a diagram explaining another example of a method for setting an alternative display area in the touch panel input device according to still another embodiment of the present invention.

### PREFERRED EMBODIMENT OF THE INVENTION

Description will hereinafter be given for preferred embodiments according to a touch panel input device of the present invention with reference to drawings, for a case where the touch panel input device of the present invention is applied to an image formation device. In the description below, since same numerals represent same components even in different drawings, description thereof will be omitted in some cases.

### Embodiment 1

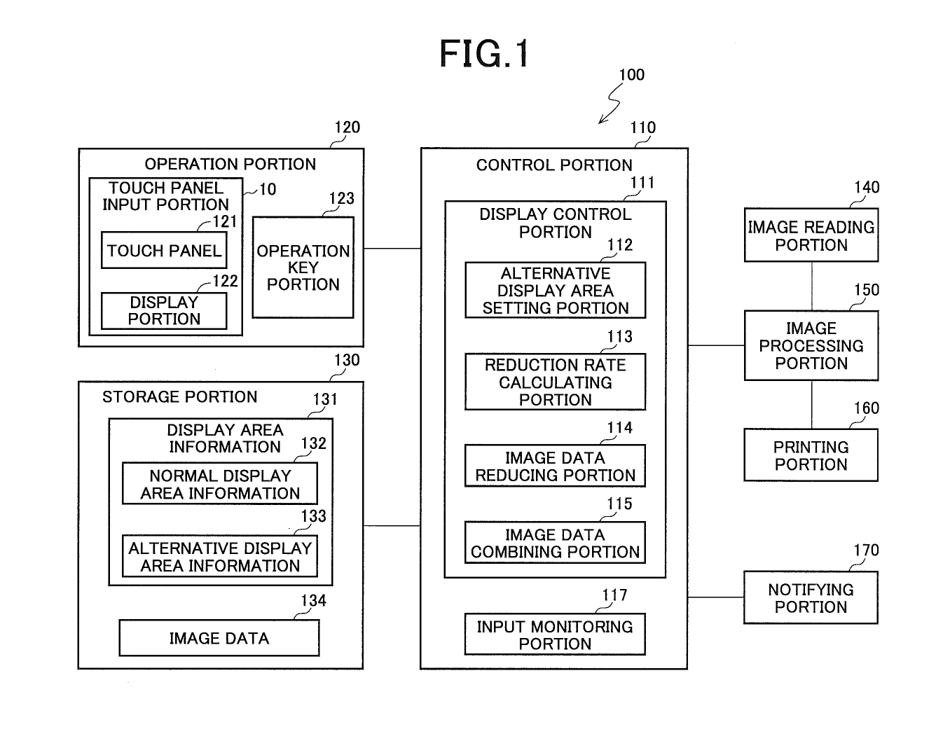

FIG. 1 is a structural diagram of an image formation device provided with a touch panel input device according to one embodiment (embodiment 1) of the present invention. An image formation device 100 has a control portion 110, an operation portion 120, a storage portion 130, an image reading portion 140, an image processing portion 150, a printing portion 160 and a notifying portion 170. Among these components, the components other than the image reading portion 140, the image processing portion 150 and the printing portion 160 relate to the touch panel input device of the present invention.

The operation portion 120 has a touch panel input portion 10 and an operation key input portion 123, and the touch panel input portion 10 is configured by, for example, a touch panel 121 in a transparent resistive film type and a display portion 122 consisting of a liquid crystal display portion and a backlight and the operation key input portion 123 is configured by a hard key using connecting contacts. The touch panel 121 of the touch panel input portion 10 is provided being overlapped with the display portion 122 having almost the same size with a display screen of the display portion 122, and a GUI (graphical user interface) for operating the image formation device is displayed on the display screen of the display portion 122. Then, the touch panel input portion 10 allows receiving input by touching a displayed part, and is for operating the image formation device based on a received user operation with the operation key input portion 123.

The control portion 110 has a display control portion 111 for controlling the operation portion 120 and an input monitoring portion 117, as well as controls the entire image formation device 100. The control portion 110 is provided with a CPU, a ROM and a RAM, which are not shown, and realizes each function by reading and executing various programs and data stored in the ROM and the storage portion 130 by the CPU. In the embodiment 1, the display control portion 111 has an alternative display area setting portion 112, a reduction rate calculating portion 113, an image data reducing portion 114 and an image data combining portion 115.

The alternative display area setting portion 112 has a function for receiving designation for an alternative display area usable by a user operation when the touch panel input portion 10 fails, and setting the alternative display area. The reduction rate calculating portion 113 has a function for calculating a reduction rate when a touch-key image is reduced and displayed in the alternative display area. The image data reducing portion 114 has a function for performing reducing processing of the touch-key image based on the reduction rate calculated by the reduction rate calculating portion 113. The image data combining portion 115 has a function for combining predetermined image data when an image is displayed in the alternative display area or an area outside the alternative display area.

Moreover, the input monitoring portion 117 has a function for monitoring whether or not there is a user operation for the touch panel input portion 10 or the operation key portion 123 of the operation portion 120 and informing input content by the user operation to the display control portion 111 of the control portion 110 or other control functional portion, which is not shown, according to the user operation.

A plurality of image data 134 displayed on the display portion 122 are stored in the storage portion 130, and the touch-key image for operating the image formation device is also stored in the storage portion 130 as the image data 134. Further, display area information 131 at a time of displaying these image data on the display portion 122 is stored in the storage portion 130 as normal display area information 132. Moreover, in a case where the alternative display area is set when the touch panel input portion 10 fails, the alternative display area information 133 is stored in the storage portion 130.

The image reading portion 140 optically reads an image from a not-shown document, and outputs read image data to the image processing portion 150. In the image processing portion 150, various image processing is performed so that the image data read by the image reading portion 140 is able to be printed by the printing portion 160 under control from the control portion 110. The printing portion 160 has a paper feed portion, an image printing portion and a paper output portion, which are not shown, and prints the image data on a sheet of recording paper by an electrophotographic system, for example.

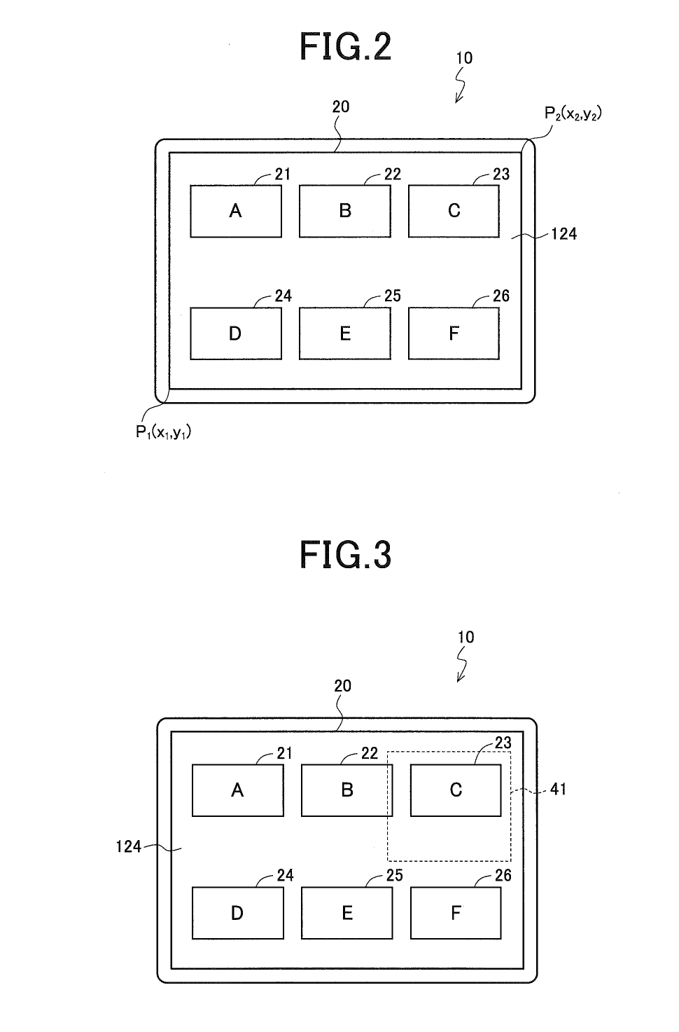

FIG. 2 is a diagram showing an example of a touch-key image displayed on a display screen in the touch panel input device according to one embodiment of the present invention. A touch-key image 20 is an image for operations having at least one or more touch keys serving as operation keys for receiving a predetermined operation when a user performs a touch operation, and has a predetermined layout (arrangement). In the present embodiment, a size of the touch-key image 20 displayed on a display screen 124 of the touch panel input portion 10 is, for example, a rectangular area having a line connecting a first coordinate position P1 (x1, y1) in a lower left end and a second coordinate position P2 (x2, y2) in an upper right end as a diagonal line, and this rectangular area serves as a normal display area that normally displays the touch-key image. Then, these first coordinate position P1 (x1, y1) and second coordinate position P2 (x2, y2) are stored in the storage portion 130 as the normal display area information 132.

Note that, in the present embodiment, though it is set above that the normal display area of the touch-key image 20 has an equal size to that of the display screen 124, the normal display area of the touch-key image may have a smaller size than that of the display screen 124. Moreover, the diagonal line for specifying the rectangular area is set as the line connecting the first coordinate position P1 in the lower left end and the second coordinate position P2 in the upper right end, but may be a line connecting a coordinate position in an upper left end and a coordinate position in a lower right end.

The touch-key screen 20 is an image including at least one or more touch keys serving as operation keys, and, in the example shown in FIG. 2, a touch key A21, a touch key B22, a touch key C23, a touch key D24, a touch key E25 and a touch key F26 are displayed with a predetermined size and arrangement. Then, it is set such that, when the touch panel 121 is subjected to a touch operation (in contact or pressed) by a user, a coordinate of the touched position is acquired into the control portion 110, and an input operation according to a touch key displayed at the coordinate of the touched position is executed. Accordingly, for example, when a displayed part of the touch key A21 is touched, an operation assigned to the touch key A21 is to be input.

When the touch panel input portion 10 fails, a touch key becomes not displayed on the display portion 112 of the touch panel input portion 10, or, even when a displayed touch key is touched, the touched position becomes not able to be read. The former results from failure of the display portion 122 and the latter results from failure of the touch panel 121, and a trouble is to be caused to the user in an input operation using the touch panel input portion 10 in either case.

FIG. 3 is a diagram showing a failure part in the touch panel input device in which the touch-key image of FIG. 2 is displayed, which shows a part where failure is generated as a failure area 41 in the touch panel input portion 10. Furthermore, in the present invention, when the touch panel input portion 10 fails, the touch-key image is displayed in an alternative display area of the touch panel input portion 10 other than the failure part so as to receive a touch operation from the user.

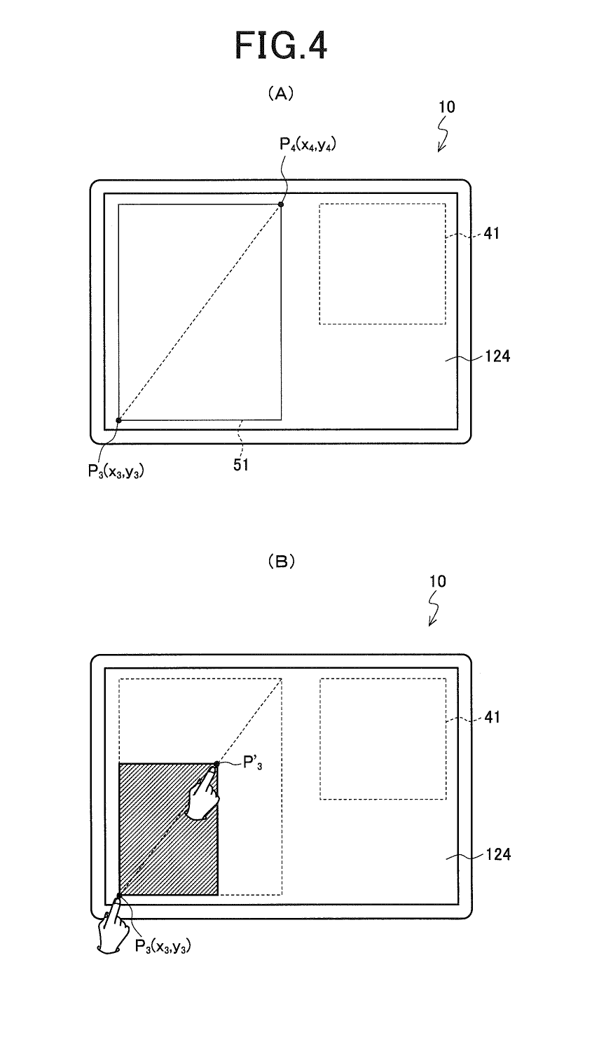

FIG. 4 is diagram explaining a method for setting an alternative display area at a time of failure. When the touch panel input portion 10 fails, the user designates an alternative display area 51 for displaying a touch-key image while avoiding a failure area 41. The alternative display area 51 is designated as, for example, a rectangular area having a line connecting a third coordinate position P3 (x3, y3) and a fourth coordinate position P4 (x4, y4), which are designated on the display screen 124, as a diagonal line, as shown in FIG. 4(A).

In this case, a position subjected to a touch operation to (made in contact with) the touch panel 121 by the user on the display screen 124 may be specified as the third coordinate position P3 (x3, y3) and a position where the user separates the user's finger on the display screen 124 after sliding a contact position on the display screen 124, that is, a position at which no contact is made may be specified as the fourth coordinate position P4 (x4, y4). Then, while the user is sliding the contact position on the display screen 124, as shown in FIG. 4(B), a rectangular area having a line connecting the third coordinate position P3 (x3, y3) and a contact position P′3 at a time of sliding as a diagonal line maybe highlighted. As highlighting, it is possible to display a contour of the rectangular area thickly or to display inside the rectangular area in a predefined color. Thereby, the user easily grasps a position and a size of the alternative display area 51 that is being selected.

From these operations, the alternative display area setting portion 112 specifies the third coordinate position P3 (x3, y3) and the fourth coordinate position P4 (x4, y4) of the alternative display area 51 to store in the storage portion 130 as the alternative display area information 133. Note that, the diagonal line for specifying the rectangular area serving as the alternative display area 51 is set as the line connecting the third coordinate position P3 in the lower left end and the fourth coordinate position P4 in the upper right end in the alternative display area 51, but may be a line connecting a coordinate position in an upper left end and a coordinate position in a lower right end in the alternative display area 51, which are specified. Note that, the third coordinate position P3 in the lower left end and the fourth coordinate position P4 in the upper right end in the alternative display area 51 correspond to a coordinate position of a start point and a coordinate position of an end point for defining the alternative display area, respectively.

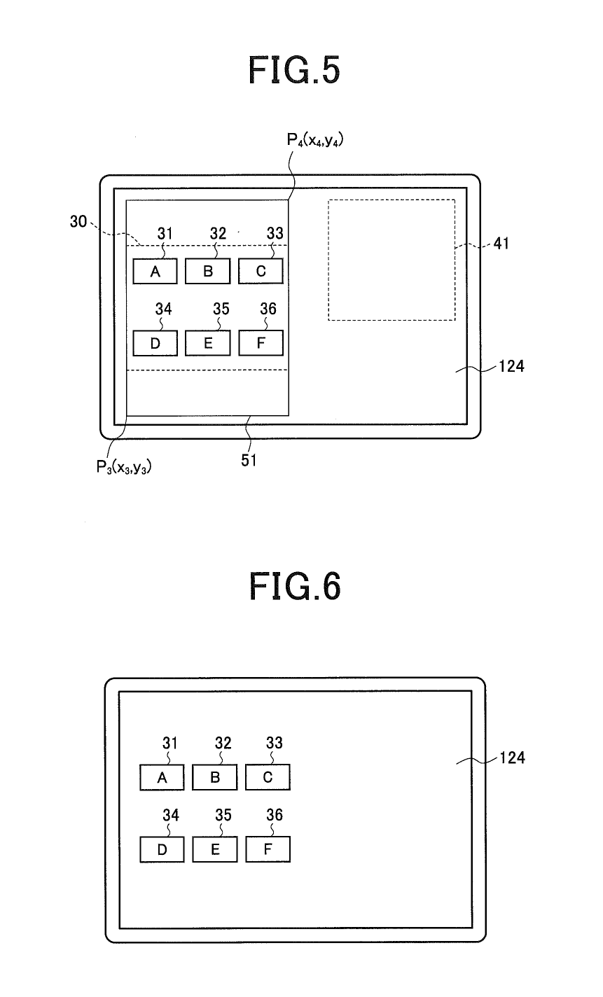

FIG. 5 is a diagram explaining a touch-key image displayed in the alternative display area and FIG. 6 is a diagram when a reduced touch-key image is displayed in the alternative display area. In FIG. 5, the failure area 41 and the alternative display area 51 are shown together. A size of a reduced touch-key image 30 is determined in accordance with a reduction rate calculated by the reduction rate calculating portion 113 by comparing a size of the normal display area and a size of the alternative display area. More specifically, the reduction rate is determined depending on a smaller ratio among a ratio by comparing lengthwise lengths of the rectangular normal display area and the rectangular alternative display area and a ratio by comparing transverse lengths thereof.

Then, the image data reducing portion 114 reduces the touch-key image in accordance with the reduction rate calculated by the reduction rate calculating portion 113, and the display control portion 111 displays the reduced touch-key image 30 so as to fit in the alterative display area 51. In an example shown in FIG. 5, the touch-key image 30 which is reduced with the reduction rate determined by the transverse length with respect to the normal touch-key image 20 is displayed so as to be positioned in the lengthwise center of the alternative display area 51.

The reduced touch-key image 30 becomes an image in which the touch key A21, the touch key B22, the touch key C23, the touch key D24, the touch key E25 and the touch key F26 in the touch-key image 20 shown in FIG. 2 are reduced as a touch key A31, a touch key B32, a touch key C33, a touch key D34, a touch key E35 and a touch key F36, respectively, and normal arrangement of the touch keys of FIG. 2 is retained as to an arrangement relationship.

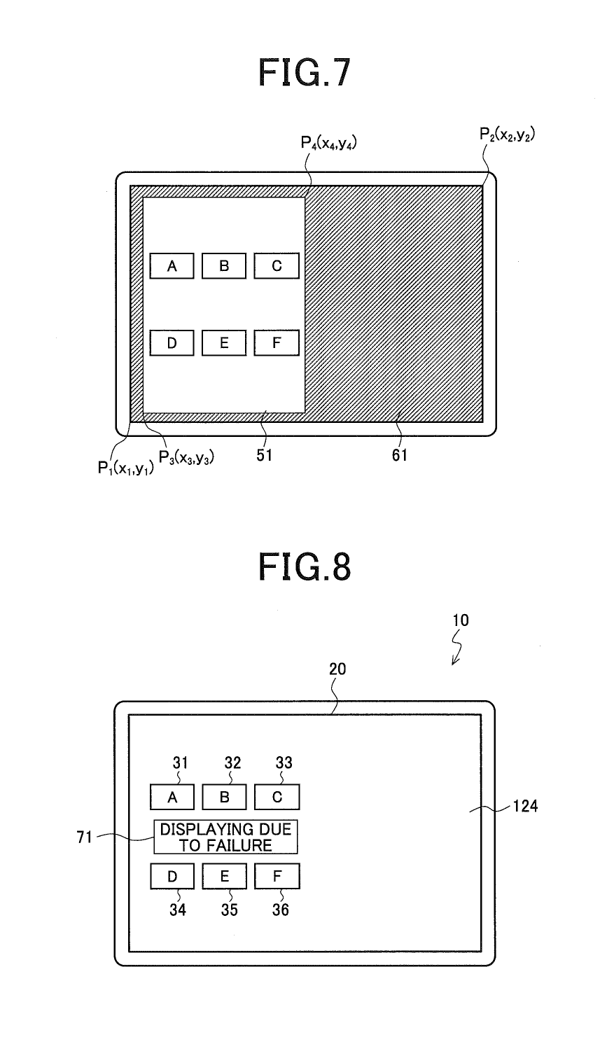

FIG. 7 is a diagram when an image different from that of the alternative display area is displayed on a display screen other than the alternative display area. Exemplary display shown in FIG. 7 is for displaying an image different from that of the alternative display area 51 in an area 61 other than the alternative display area 51, in which display is performed, for example, so as to differentiate a background color of the alternative display area 51 from a color combination of the area 61 or so that the area 61 other than the alternative display area 51 has a predetermined pattern. Such display of the area 61 other than the alternative display area 51 is possible when a function of the display portion 122 is normal and a function of the touch panel 121 fails, and this makes it possible for the user to recognize a failure area visually.

FIG. 8 is a diagram when a caution image 71 is displayed together in the alternative display area. In an example shown in FIG. 8, when a reduced touch-key image is displayed in the alternative display area, for example, display is performed by superimposing the caution image 71 of “displaying due to failure”. This caution image 71 is stored in the storage portion 130 as image data 134 and superimposed with the touch-key image by the image data combining portion 115. At this time, the caution image 71 is reduced and displayed so as not to overlap a touch key of the touch-key image or subjected to image processing so as to be displayed in a translucent state. This makes it possible for the user to recognize that the touch panel input portion 10 is being in failure. Note that, the caution image 71 may be displayed at a position not to overlap the touch-key image, as long as being in the alternative display area 51.

Moreover, as shown in FIG. 1, the notifying portion 170 may be provided so as to notify the user that the touch panel input portion 10 is being in failure by sound or notify it by blinking of a lamp, for example, when the touch panel input portion 10 is operated.

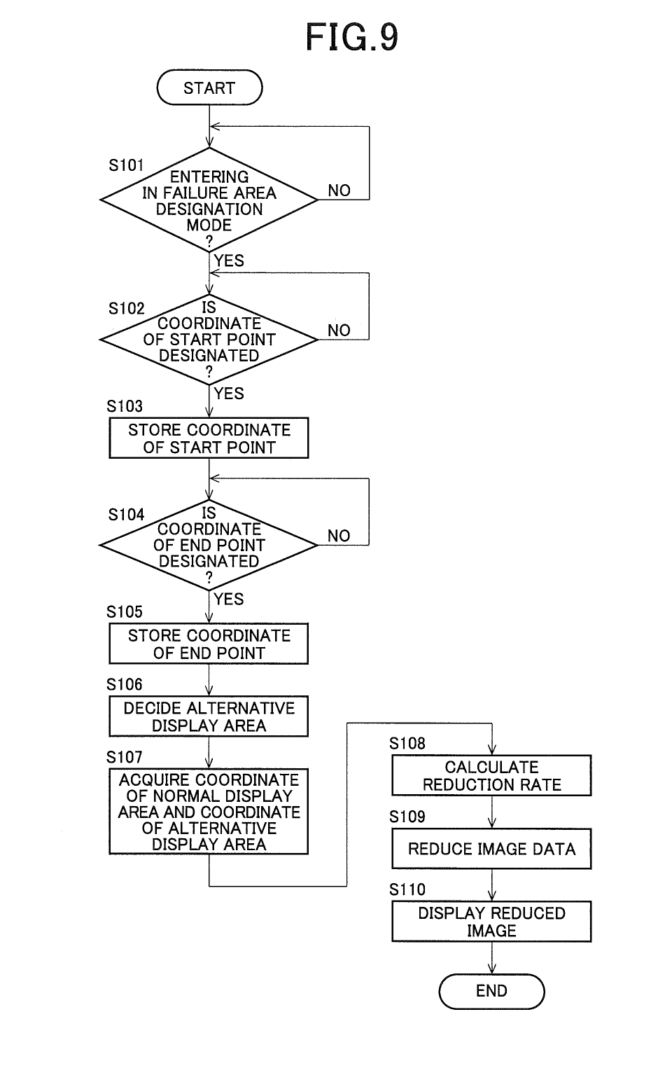

Next, description will be given for a processing flow in the touch panel input device of the present invention. FIG. 9 is a flowchart showing processing procedure of the touch panel input device according to one embodiment of the present invention.

First, the control portion 110 judges whether the touch panel input device enters a failure area designation mode (step S101). The failure area designation mode becomes able to be selected when the user presses a predetermined key of the operation key portion 123 of the operation portion 120 or, if a failure part is not related, performs a predetermined touch operation from the touch panel input portion 10. When the user selects the failure area designation mode from the operation portion 120, the input monitoring portion 117 informs that an operation for selecting the failure area designation mode is performed to the display control portion 111 of the control portion 110.

When it is judged that the touch panel input device does not enter the failure area designation mode (in the case of NO at step S101), monitoring of whether to enter the failure area designation mode is continued. Further, when it is judged that the touch panel input device enters the failure area designation mode (in the case of YES at step S101), the procedure moves to step S102, and the alternative display area setting portion 112 judges whether a coordinate of a start point of the alternative display area, that is, the above-described third coordinate position P3 (x3, y3) is designated.

When the coordinate of the start point is not designated (in the case of NO at step S102), it waits until the coordinate of the start point is designated. Further, when the user touches the touch panel 121 and the coordinate of the start point is designated (in the case of YES at step S102), the alternative display area setting portion 112 stores the coordinate of the start point in the storage portion 130 as the alternative display area information 133 (step S103).

Subsequent to step S103, the procedure moves to step S104, and the alternative display area setting portion 112 judges whether a coordinate of an end point of the alternative display area, that is, the above-described fourth coordinate position P4 (x4, y4) is designated. When the coordinate of the end point is not designated (in the case of NO at step S104), then it waits until the coordinate of the end point is designated. When a position where the finger is separated from the touch panel 121 is set as designation of the coordinate position of the end point, while a contact position is being slid, as shown in FIG. 4(B), a rectangular area having a line connecting the coordinate position of the start point and the contact position at a time of sliding the finger as a diagonal line may be highlighted.

When the coordinate of the end point is designated by removing his/her finger from the touch panel 121 by the user (in the case of YES at step S104), then the alternative display area setting portion 112 stores the coordinate of the endpoint in the storage portion 130 as the alternative display area information 133 (step S105). The alternative display area setting portion 112 then decides the alternative display area 51, for example, by raising a predetermined flag (step S106) and informs the reduction rate calculating portion 113 that the alternative display area 51 is decided.

Note that, in the above-described method, though it is set that the coordinates of the start point and the end point are designated by detecting the position where the finger of the user or the like is in contact and the position where it is separated, respectively, the coordinates of the start point and the end point may be certainly designated by other method.

Subsequently, the reduction rate calculating portion 113 acquires a coordinate of a display area in which a touch-key screen is normally displayed and the coordinate of the alternative display area 51 from the storage portion 130 into the control portion 110 (step S107). Further, the reduction rate calculating portion 113 calculates a reduction rate at a time of displaying the touch-key image in the alternative display area 51 (step S108), and informs the image date reducing portion 114 of the calculated reduction rate. The reduction rate is able to be calculated by the method as described above.

Subsequently, the image data reducing portion 114 acquires the normal touch-key image, which is stored in the storage portion 130, into the control portion 110, and reduces the touch-key image in accordance with the reduction rate informed from the reduction rate calculating portion 113 (step S109). The display control portion 111 then displays the touch-key image 30 reduced by the image data reducing portion 114 in the alternative display area 51 to end processing.

Note that, as shown in FIG. 7, when an image different from that of the alternative display area 51 is displayed in the area 61 other than the alternative display area 51, the display control portion 111 performs display so as to differentiate a background color of the alternative display area 51 from a color combination of the area 61 other than the alternative display area 51 or so that the area 61 other than the alternative display area 51 has a predetermined pattern.

In addition, as shown in FIG. 8, when the caution image 71 is superimposed and displayed, the image data combining portion 115 reads a predetermined caution image from the storage portion 130 to superimpose with the touch-key image reduced by the image data reducing portion 114 for displaying or to display at a position not overlapping the touch-key image in the alternative display area 51.

### Embodiment 2

As above, though description has been given in the embodiment 1 for a case where one alternative display area is designated, it is also possible to designate a plurality of alternative display areas. Description will be given below as an embodiment 2 for a case where two alternative display areas are designated.

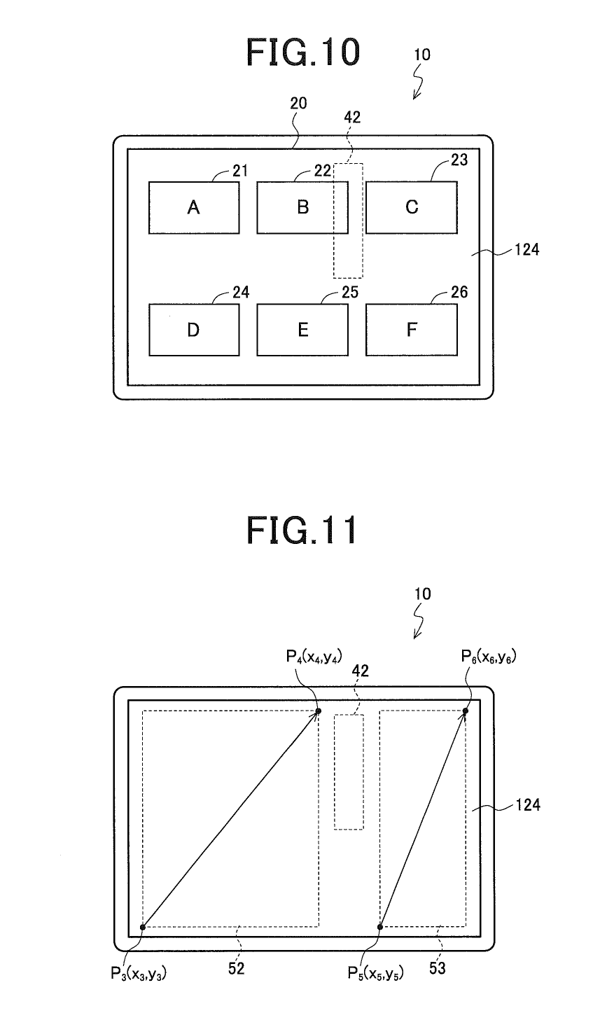

FIG. 10 is a diagram showing a failure part in the touch panel input device in which the touch-key image of FIG. 2 is displayed, which shows a part where failure is caused as a failure area 42 in the touch panel input portion 10. Here, the failure area 42 is closer to a center of a screen than the failure area 41 shown in FIG. 3. In this case, the user is able to set the alternative display areas on both sides of the failure area 42 of the display screen 124 while avoiding the failure area 42.

FIG. 11 is a diagram explaining an example of a method for setting alternative display areas when there is a failure part shown in FIG. 10. When the touch panel input portion 10 fails, the user designates a first alternative display area 52 and a second alternative display area 53 for displaying a touch-key image while avoiding the failure area 42. The first alternative display area 52 is designated as a rectangular area having the line connecting the third coordinate position P3 (x3, y3) and the fourth coordinate position P4 (x4, y4), which are designated on the display screen 124, as a diagonal line. Moreover, the second alternative display area 53 is designated as a rectangular area having a line connecting a fifth coordinate position P5 (x5, y5) and a sixth coordinate position P6 (x6, y6), which are designated on the display screen 124, as a diagonal line. The method for designating the first and second alternative display areas 52 and 53 is able to be performed with a method same as the case of the embodiment 1 shown in FIG. 4. Note that, the fifth coordinate position P5 in the lower left end and the sixth coordinate position P6 in the upper right end in the second alternative display area 53 correspond to a coordinate position of a start point and a coordinate position of an end point for defining the second alternative display area 53, respectively.

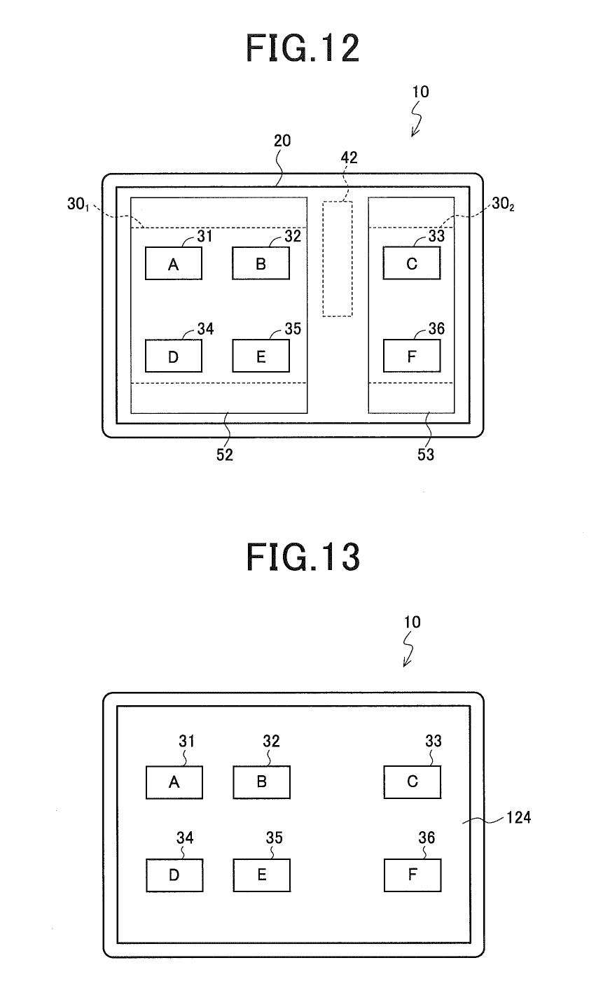

FIG. 12 is a diagram explaining touch-key images displayed in the alternative display areas, and FIG. 13 is a diagram when a reduced touch-key image is displayed in the alternative display area. In FIG. 12, the failure area 42 and the first and second alternative display areas 52 and 53 are shown together. As shown in FIG. 12, a first touch-key image 301 that includes the touch key A31, the touch key B32, the touch key D34 and the touch key E35, each of which is reduced, is displayed in the first alternative display area 52, and a second touch-key image 302 that includes the touch key C33 and the touch key F36, each of which is reduced, is displayed in the second alternative display area 53. Here, the first touch-key image 301 and the second touch-key image 302 may have a different reduction rate.

In this manner, the embodiment 2 is different from the case of the embodiment 1 in terms of that a normal touch-key image is displayed in a divided manner in the two alternative display areas 52 and 53 and is reduced and displayed in each of the alternative display areas. Accordingly, in the embodiment 2, a function becomes necessary for dividing, when a plurality of alternative display areas are designated, a touch-key image that is normally displayed according to the plurality of alternative display areas.

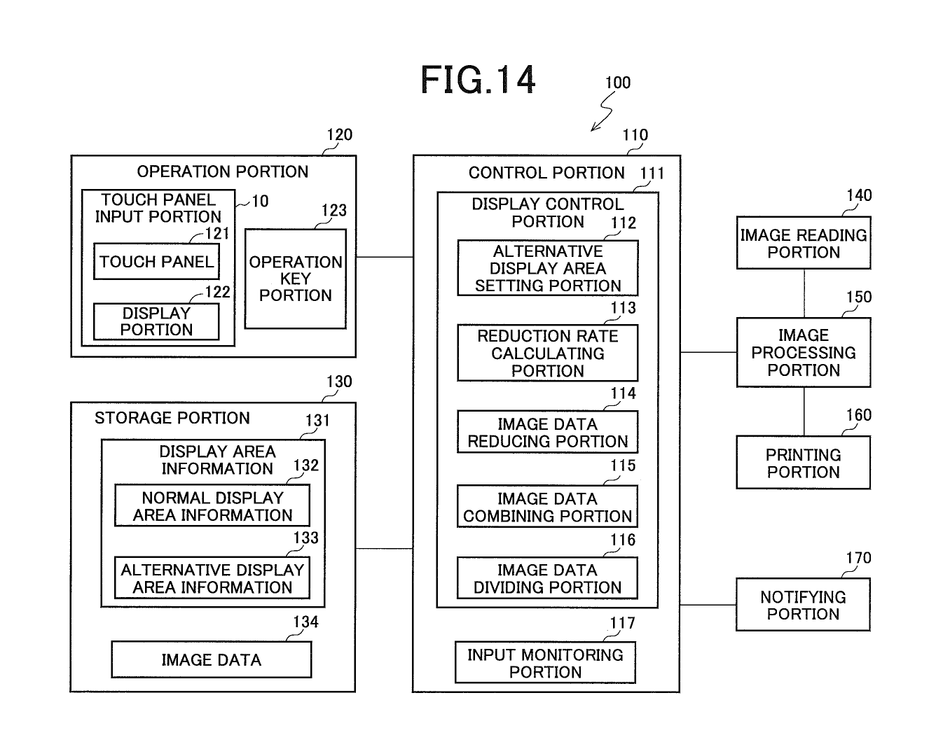

FIG. 14 is a structural diagram of an image formation device provided with the touch panel input device according to another embodiment (embodiment 2) of the present invention. The image formation device 100 has the control portion 110, the operation portion 120, the storage portion 130, the image reading portion 140, the image processing portion 150, the printing portion 160 and the notifying portion 170. Further, it is different from the embodiment 1 in terms of that the display control portion 111 of the control portion 110 has an image data dividing portion 116, and other components are the same as the image formation device shown in FIG. 1 (embodiment 1). The image data dividing portion 116 has a function for determining a method for dividing a touch-key image when the touch-key image is divided and displayed in a plurality of alternative display areas.

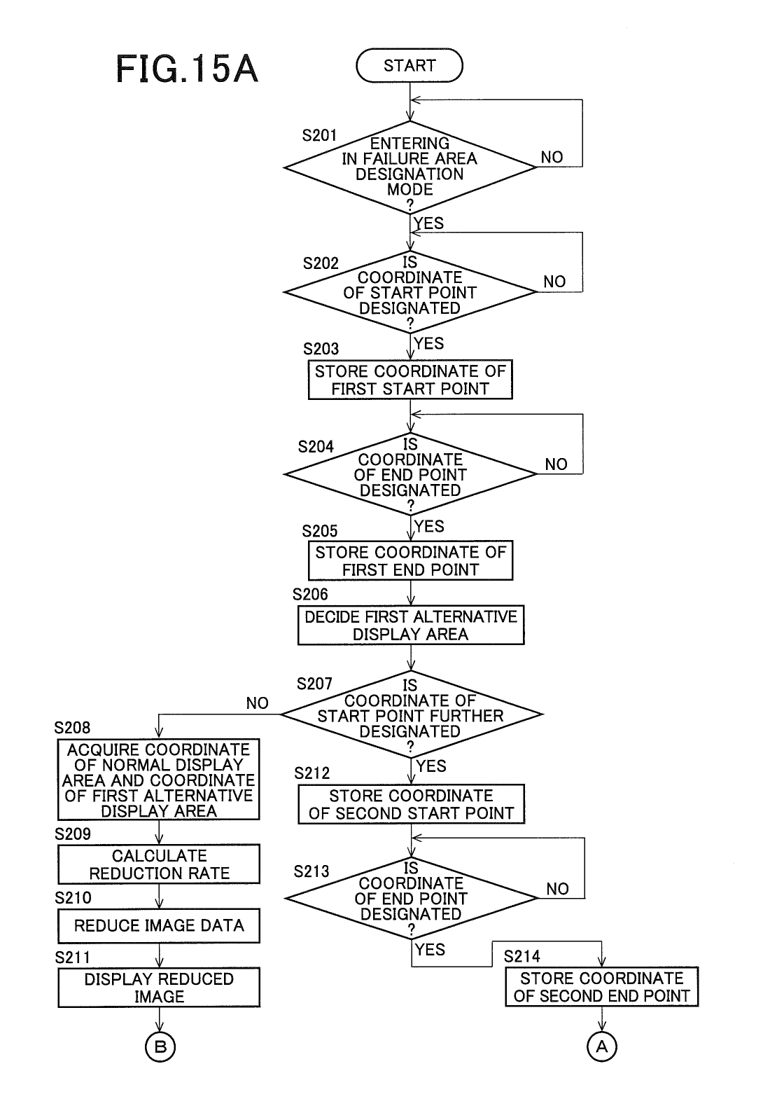

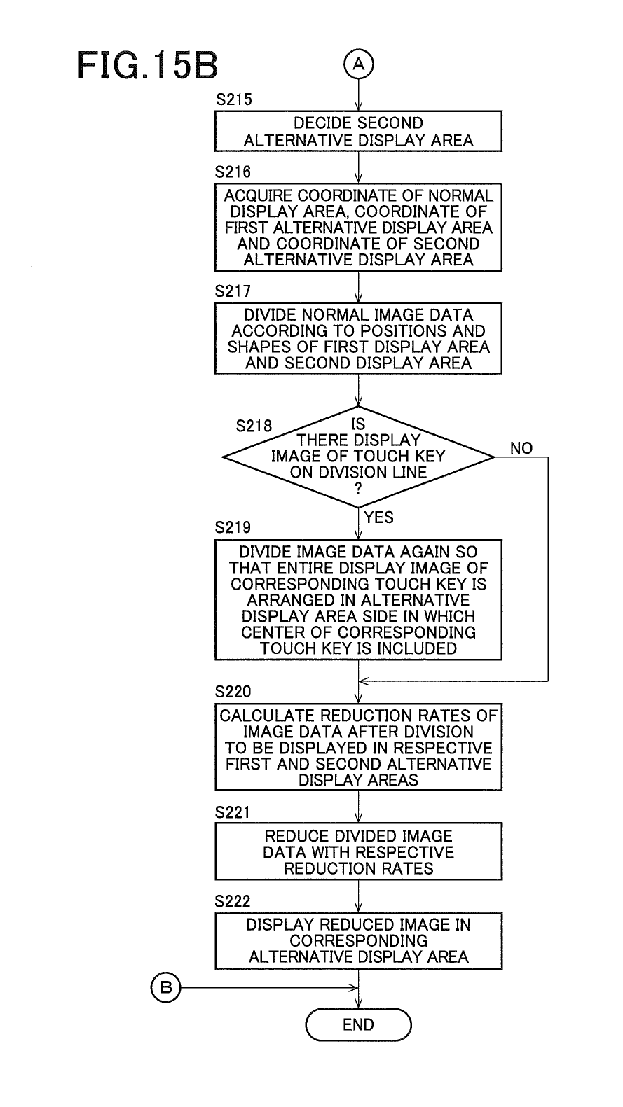

Next, description will be given for a processing flow in the embodiment 2. FIG. 15A and FIG. 15B are flowcharts showing processing procedure of the touch panel input device according to another embodiment of the present invention, and the flowchart of FIG. 15B shows continuation of the flowchart of FIG. 15A.

First, since processing substantially the same as the processing from step S101 to step S106 in the flowchart shown in FIG. 9 is performed for processing from step S201 to step S206 in the flowchart of FIG. 15A, the description thereof will be omitted. In the flowchart shown in FIG. 15A, however, “coordinate of start point”, “coordinate of end point” and “ alternative display area” in the flowchart shown in FIG. 9 are set as “coordinate of first start point”, “coordinate of first end point” and “first alternative display area”, respectively.

Next, at step S207, the alternative display area setting portion 112 judges whether a coordinate of a start point of the alternative display area, that is, the fifth coordinate position P5 (x5, y5) shown in FIG. 11 is further designated. When the coordinate of the second start point of the alternative display area is not designated (in the case of NO at step S207), the procedure moves to step S208 to carry out subsequent processing. Here, as to judgment when the coordinate of the second start point is not designated, it is judged that the coordinate of the second start point is not designated when there is no touch operation to the touch panel 121 by the user within a predetermined time.

Next, since processing substantially the same as the processing from step S107 to step S110 in the flowchart shown in FIG. 9 is performed for processing from step S208 to step S211, the description thereof will be omitted. Note that, processing reaching step S211 through step S201 to step S207 is the same as the case of the embodiment 1 in which one alternative display area is designated, and is substantially the same processing as the processing by the flowchart shown in FIG. 9.

When the coordinate of the start point of the alternative display area is further designated at step S207 (in the case of YES), the alternative display area setting portion 112 stores the coordinate of the second start point in the storage portion 130 as the alternative display area information 133 (step S212). Subsequently, the procedure moves to step S213, and the alternative display area setting portion 112 judges whether the coordinate of the second end point of the second alternative display area, that is, the above-described sixth coordinate position P6 (x6, y6) is designated. When the coordinate of the end point is not designated (in the case of NO at step S213), then, it waits until the coordinate of the end point is designated.

Here, in the same manner as the designation of the first alternative display area, when a position where the finger is removed from the touch panel 121 is set as designation of the coordinate position of the end point, while a contact position is being slid, as shown in FIG. 4(B), a rectangular area having a line connecting the coordinate position of the start point and the contact position at a time of sliding the finger as a diagonal line may be highlighted. When the coordinate of the second end point is designated by separating his/her finger from the touch panel 121 by the user (in the case of YES at step S213), then the alternative display area setting portion 112 stores the coordinate of the second end point in the storage portion 130 as the alternative display area information 133 (step S214), and the alternative display area setting portion 112 decides the second alternative display area 53 (step S215) and informs the image data dividing portion 116 that the second alternative display area 53 is decided.

The image data dividing portion 116 acquires a coordinate of a display area in which a touch-key screen is normally displayed, the coordinate of the first alternative display area 52 and the coordinate of the second alternative display area 53 into the control portion 110 from the storage portion 130 (step S216). Further, the image data dividing portion 116 firstly divides image data of the touch-key image that is normally displayed according to positions and shapes of the first and second alternative display areas (step S217).

Subsequently, the image data dividing portion 116 judges whether a display image of a touch key is positioned on a division line of the touch-key image that is divided at step S217 (step S218). When the display image of the touch key is not positioned on the division line (in the case of NO at step S218), then, the procedure moves to step S220. Further, when the display image of the touch key is positioned on the division line (in the case of YES at step S218), the procedure moves to step S219, and after performing division again so that the entire display image of the touch key that is on the division line is included in the alternative display area side in which the center of the display image of the touch key that is on the division line is included, the procedure moves to step S220.

At step S220, the reduction rate calculating portion 113 calculates reduction rates of image data of the touch-key images after division, which are displayed in the respective first and second alternative display areas 52 and 53, based on division data of the touch-key image that is normally displayed, which is acquired from the image data dividing portion 116, and the coordinates of the first and second alternative display areas 52 and 53, which are acquired from the storage portion, and informs the image data reducing portion 114 of the calculated reduction rates.

Subsequently, the image data reducing portion 114 performs reducing processing in accordance with the reduction rates in the first and second alternative display areas, which are informed from the reduction rate calculating portion 113, with respect to the respective division data of the touch-key images that are normally displayed, which are acquired from the image data dividing portion 116 (step S221). The display control portion 111 then displays the first touch-key image 301 that is reduced by the image data reducing portion 114 in the first alternative display area 52 as well as displays the second touch-key image 302 in the second alternative display area 53 to end processing. In this manner, when there is a failure area in the center of the display screen 124, by providing the second alternative display area, it is possible to display the touch-key images on both sides of the failure area.

### Embodiment 3

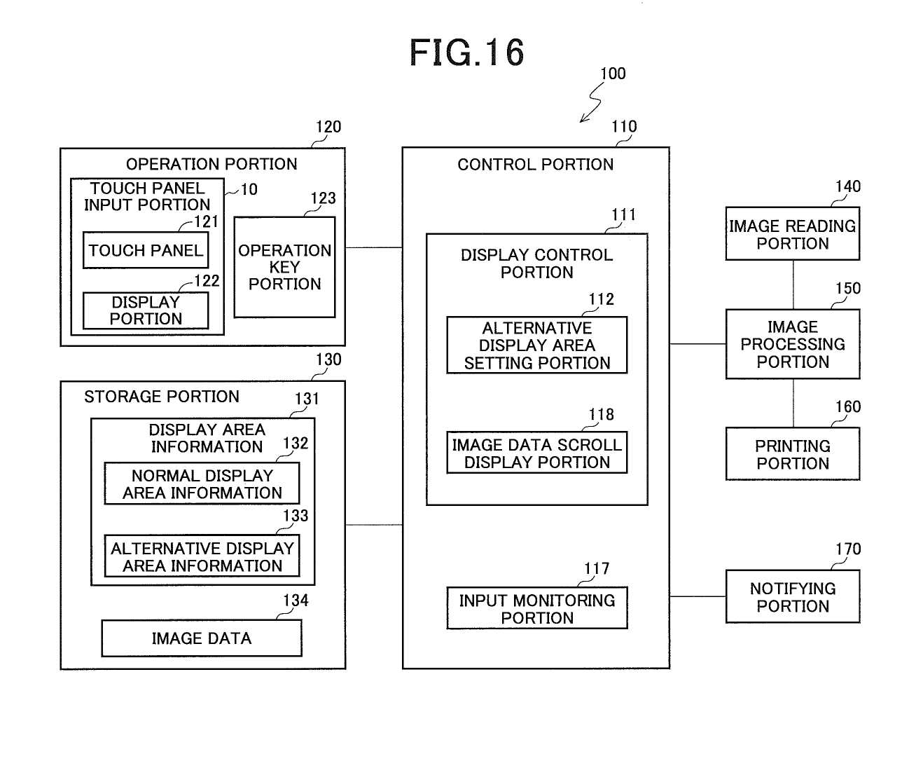

Though the reduced touch-key image is displayed in the alternative display area in the first embodiment and the second embodiment, the touch-key image is displayed in the alternative display area in a scrollable manner in a third embodiment. FIG. 16 is a structural diagram of an image formation device provided with a touch panel input device according to still another embodiment (embodiment 3) of the present invention. The image formation device 100 has the control portion 110, the operation portion 120, the storage portion 130, the image reading portion 140, the image processing portion 150, the printing portion 160 and the notifying portion 170. It is the same as the image formation device shown in FIG. 1 (embodiment 1) excluding that the display control portion 111 of the control portion 110 has the alternative display area setting portion 112 and an image data scroll display portion 118 in the embodiment 3. Here, the alternative display area setting portion 112 has a function for receiving designation for an alternative display area usable by a user operation when the touch panel input portion 10 fails, and setting the alternative display area, and the image data scroll display portion 118 has a function for displaying a touch-key image in the alternative display area in a scrollable manner by a user operation.

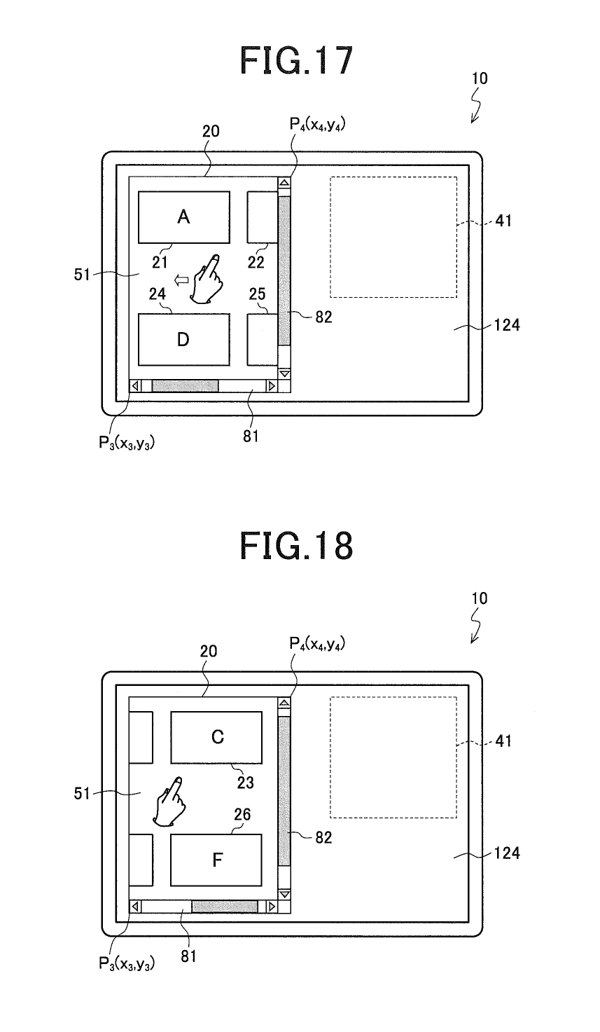

FIG. 17 and FIG. 18 are diagrams when a touch-key image is displayed in an alternative display area in a scrollable manner. FIG. 17 shows the touch-key image 20 that is displayed first in the alternative display area 51. In the embodiment 3, a part of the touch-key image that is normally displayed is displayed as it is in the alternative display area 51. Furthermore, a horizontal scroll bar 81 and a vertical scroll bar 82 are displayed together with the touch-key image in the alternative display area 51. Here, since a method for setting the alternative display area 51 is the same as the method described in the embodiment 1, the description thereof will be omitted.

Then, the touch-key image 20 is to be scrolled in a predetermined direction by, for example, performing a drag operation of a scroll box of the horizontal scroll bar 81 or the vertical scroll bar 82 or touching a scroll arrow. In addition, also by dragging the touch-key image 20 itself, the touch-key image 20 is able to be scrolled. For example, by performing a drag operation of the touch-key image 20 shown in FIG. 17 in an illustrated direction (left direction), as shown in FIG. 18, the touch-key image 20 displayed in the alternative display area 51 is scrolled. Then, at a time of the drag operation, a flipping operation may be added to make a speed of screen scroll faster.

Note that, in order to notify the user that the touch panel input portion fails, as shown in FIG. 16, the notifying portion 170 maybe provided, for example, so as to notify the user that the touch panel input portion 10 is being in failure by sound or notify it by blinking of a lamp, when the touch panel input portion 10 is operated.

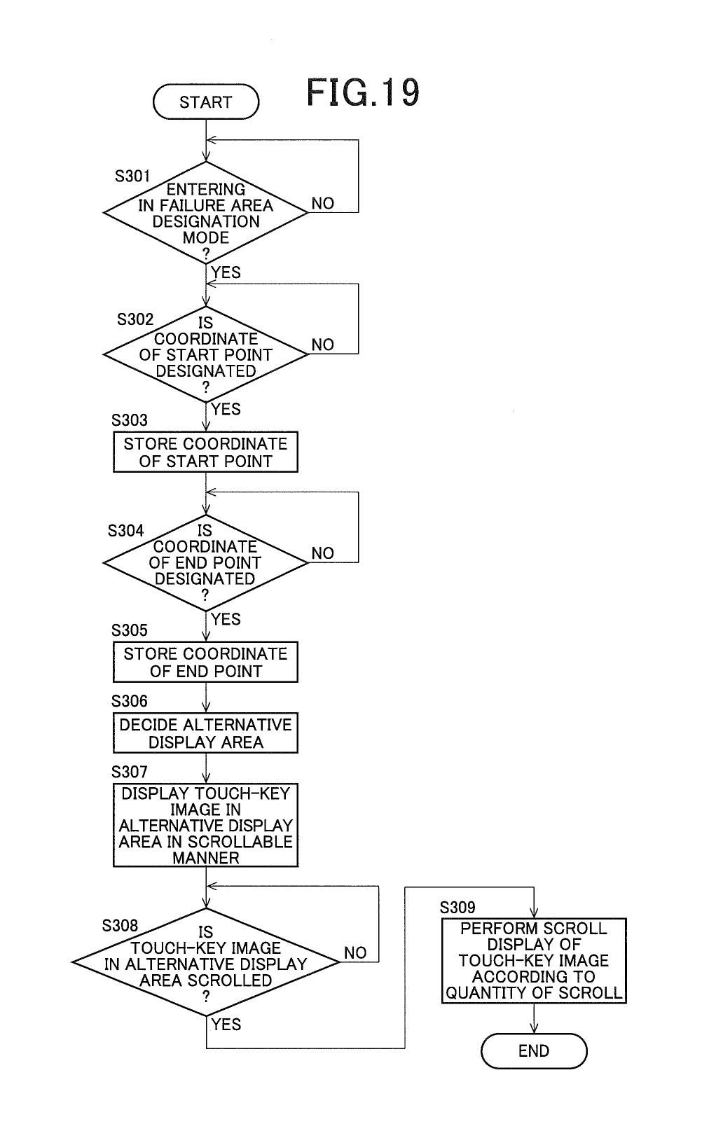

Next, description will be given for a processing flow in the embodiment 3. FIG. 19 is a flowchart showing processing procedure of the touch panel input device according to still another embodiment of the present invention.

First, since processing substantially the same as the processing from step S101 to step S106 in the flowchart shown in FIG. 9 is performed for processing from step S301 to step S306 in the flowchart of FIG. 19, the description thereof will be omitted.

After the alternative display area 51 is decided at step S306, then, the image data scroll display portion 118 acquires the coordinate of the alternative display area 51 from the storage portion 130 into the control portion 110 and displays the touch-key image 20 in the alternative display area 51 in a scrollable manner (step S307). Further, whether or not there is a scroll operation for the touch-key image 20 displayed in the alternative display area 51 is judged (step S308), and when there is no scroll operation (in the case of NO), it waits until a scroll operation is performed. Here, as to judgment of whether there is a scroll operation, it is possible to perform judgment depending on whether the input monitoring portion 117 receives notification that there is a scroll operation from the operation portion 120.

When there is a scroll operation for the touch-key screen (in the case of YES at step S308), the image data scroll display portion 118 performs scroll display of the touch-key image 20 according to a quantity and direction of scroll to end processing.

While designation of two points avoiding a failure area of the touch panel portion 10 is received from the user and a rectangular area having a line connecting these two points as a diagonal line is set as the alternative display area in the examples above, another method for setting the alternative display area will be described below.

### Embodiment 4

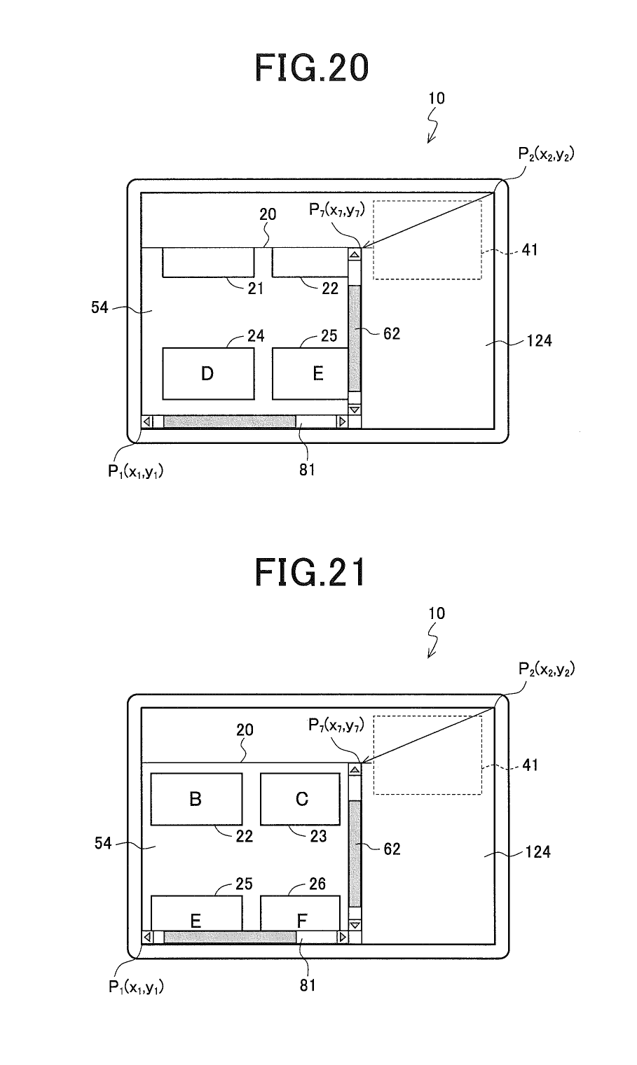

FIG. 20 is a diagram explaining another example of a method for setting an alternative display area. In an example shown in FIG. 20, it is set that there is the failure area 41, for example, near the second coordinate position P2 (x2, y2) in the upper right end, which is one of apexes of the touch-key image 20 that is normally displayed. It is set that, after selecting a predetermined failure area designation mode by the method described above, the user performs an operation for making in contact with the second coordinate position P2 (x2, y2) to slide the contact position and making not in contact at a seventh coordinate position P7 (x7, y7) other than the failure area 41. When the second coordinate position P2 (x2, y2) which is an apex is subjected to the drag operation in this manner, the alternative display area setting portion 112 specifies a position of an apex opposed to the second coordinate position P2 (x2, y2) of the touch-key image 20 that is normally displayed, namely, the first coordinate position P1 (x1, y1) in the lower left end. The alternative display area setting portion 112 then sets, as an alternative display area 54, a rectangular area having a line connecting the specified first coordinate position P1 (x1, y1) and the seventh coordinate position P7 (x7, y7) specified by the sliding operation as a diagonal line.

The image data scroll display portion 118 then displays the touch-key image 20 in the alternative display area 54 in a scrollable manner. In this case, when the seventh coordinate position P7 (x7, y7) is in the failure area 41 during dragging, the touch panel input portion 10 is not able to specify the seventh coordinate position P7 (x7, y7), but, when the seventh coordinate position P7 (x7, y7) is outside the failure area 41, is able to specify the seventh coordinate position P7 (x7, y7). Then, during a period when a contact position is slid and when it is possible to specify the seventh coordinate position P7 (x7, y7), the image data scroll display portion 118 may display the touch-key image 20 in the alternative display area 54 in a scrollable manner. This makes it possible to set the alternative display area 54 reliably.

### Embodiment 5

FIG. 21 is a diagram explaining still another example of a method for setting an alternative display area. While the method for setting the alternative display area 54 is the same as the embodiment 3 in the embodiment 4, the image data scroll display portion 118 displays the touch-key image 20 itself in the alternative display area 54 in a state of being dragged when displaying the touch-key image 20 in the alternative display area 54 in a scrollable manner. Accordingly, when the user performs an operation for making not in contact at the seventh coordinate position P7 (x7, y7), a display part of the touch-key image 20 displayed in the alternative display area 54 becomes different between the embodiment 4 and an embodiment 5. Note that, it is possible to set the alternative display area 54 reliably in the case of the embodiment 5 as well.

### Embodiment 6

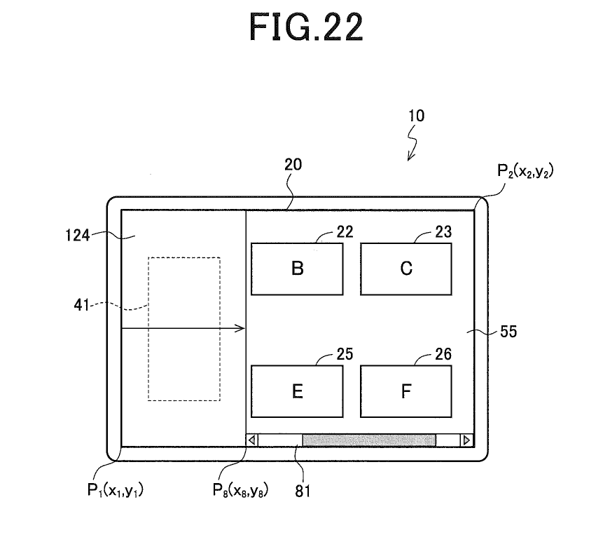

FIG. 22 is a diagram explaining still another example of a method for setting an alternative display area. In an example shown in FIG. 22, it is set that the failure area 41 is on a left side of the touch-key image 20 that is normally displayed. It is set that, after selecting a predetermined failure area designation mode by the method described above, the user performs an operation for making in contact with a left side part of the touch-key image 20 that is normally displayed to slide the contact position and making not in contact at a position avoiding the failure area 41. When the left side which is one side of the touch-key image 20 that is normally displayed is subjected to the drag operation in this manner, the alternative display area setting portion 112 judges to be equivalent to that the first coordinate position P1 (x1, y1) which is an apex of the touch-key image 20, which is included in the left side, is dragged to an eighth coordinate position P8 (x8, y8) shown in FIG. 22.

Further, the alternative display area setting portion 112 specifies that a position of an apex opposed to the first coordinate position P1 (x1, y1) of the touch-key image 20 that is normally displayed is the second coordinate position P2 (x2, y2). The alternative display area setting portion 112 then sets, as an alternative display area 55, a rectangular area having a line connecting the specified second coordinate position P2 (x2, y2) and the eighth coordinate position P8 (x8, y8) as a diagonal line.

The image data scroll display portion 118 then displays the touch-key image 20 in the alternative display area 55 in a scrollable manner. In this case, in the same manner as the embodiment 4, during a period when the user is sliding a contact position and when the eighth coordinate position P8 (x8, y8) is able to be specified, the image data scroll display portion 118 may display the touch-key image 20 in the alternative display area 55 in a scrollable manner.

Note that, also in the embodiments 2 to 6, in the same manner as the embodiment 1, as shown in FIG. 7, an image different from that of the alternative display area may be displayed in an area other than the alternative display area, and further, the caution image 71 may be superimposed and displayed as shown in FIG. 8.

### EXPLANATIONS OF LETTERS OR NUMERALS

10 . . . touch panel input portion, 20 . . . touch-key image, 21, 22, 23, 24, 25, 26, 31, 32, 33, 34, 35 and 36 . . . touch key, 30, 301 and 302 . . . reduced touch-key image, 41 and 42 . . . failure area, 51, 52, 53, 54 and 55 . . . alternative display area, 61 . . . area, 71 . . . caution image, 81 . . . horizontal scroll bar, 82 . . . vertical scroll bar, 100 . . . image formation device, 110 . . . control portion, 111 . . . display control portion, 112 . . . alternative display area setting portion, 113 . . . reduction rate calculating portion, 114 . . . image data reducing portion, 115 . . . image data combining portion, 116 . . . image data dividing portion, 117 . . . input monitoring portion, 118 . . . image data scroll display portion, 120 . . . operation portion, 121 . . . touch panel, 122 . . . display portion, 123 . . . operation key portion, 124 . . . display screen, 130 . . . storage portion, 131 . . . display area information, 132 . . . normal display area information, 133 . . . alternative display area information, 134 . . . image data, 140 . . . image reading portion, 150 . . . image processing portion, 160 . . . printing portion, and 170 . . . notifying portion.

1. A touch panel input device which displays a touch-key image including at least one or more touch keys on a display screen, detects a fact that the touch key is contacted, and receives input according to the touch key displayed in a contacted area, wherein
the touch panel input device includes an alternative display area setting portion for receiving designation of an alternative display area which is usable at a time of failure as well as a display control portion for performing display in a state of retaining an arrangement relationship of the one or more touch keys in the alternative display area.

2. The touch panel input device according to claim 1, wherein
the display control portion includes a reduction rate calculating portion for calculating a reduction rate when the touch-key image is displayed in the alternative display area and
an image data reducing portion for reducing the touch-key image based on the reduction rate calculated by the reduction rate calculating portion, and
displays the touch-key image reduced by the image data reducing portion in the alternative display area.

3. The touch panel input device according to claim 1, wherein
the alternative display area setting portion receives designation of a plurality of the alternative display areas.

4. The touch panel input device according to claim 1, wherein
the display control portion has an image data scroll display portion for displaying the touch-key image to be scrollable in the alternative display area.

5. The touch panel input device according to claim 4, wherein
a scroll bar is displayed along with the touch-key image in the alternative display area.

6. The touch panel input device according to claim 4, wherein
a touch-key image which is initially displayed in the alternative display area is a part of a touch-key image normally displayed on the display screen.

7. The touch panel input device according to claim 1, wherein
the alternative display area setting portion specifies a coordinate position of a start point and a coordinate position of an end point which are designated on the display screen and sets a rectangular area, as the alternative display area, which has a line connecting the coordinate position of the start point and the coordinate position of the end point as a diagonal line.

8. The touch panel input device according to claim 7, wherein
the alternative display area setting portion specifies a position at which a user has a contact on the display screen as the coordinate position of the start point and specifies a position at which, after the user slides the contact position on the display screen, no contact is made by the user on the display screen as the coordinate position of the end point.

9. The touch panel input device according to claim 8, wherein
when the user is sliding the contact position on the display screen, the alternative display area setting portion highlights a rectangular area having a line connecting the coordinate position of the start point and the contact position when sliding as a diagonal line.

10. The touch panel input device according to claim 4, wherein
the alternative display area setting portion specifies a position of an apex designated by a drag operation from a peripheral part of the touch-key image normally displayed and sets, as the alternative display area, a rectangular area having a line connecting the specified apex and an apex of the touch-key image normally displayed, which is at a position opposed to the specified apex, as a diagonal line.

11. The touch panel input device according to claim 10, wherein
the touch-key image is moved and displayed according to a drag operation from a peripheral part of the display screen.

12. The touch panel input device according to claim 1, wherein
a predetermined image different from that of the alternative display area is displayed on a display screen outside the alternative display area.

13. The touch panel input device according to claim 1, wherein
a caution image to the effect that the touch panel input device does not work is displayed on the alternative display area.

14. An image formation device provided with the touch panel input device according to claim 1.
